(19) United States
(12) Patent Application Publication
(10) Pub. No.: US 2021/0148124 A1
(43) Pub. Date: May 20, 2021

(54) DIGITAL FABRICATION OF CONCRETE FORMWORK

(71) Applicant: PCL Construction Enterprises, Inc., Denver, CO (US)

(72) Inventors: Nickolas J. Kurth, Denver, CO (US); Matthew S. Glassman, Denver, CO (US)

(21) Appl. No.: 16/949,826

(22) Filed: Nov. 16, 2020

Related U.S. Application Data
(60) Provisional application No. 62/935,804, filed on Nov. 15, 2019.

(51) Int. Cl. E04G 9/02; E04G 17/02; B33Y 80/00

(52) U.S. Cl. CPC E04G 9/02; B33Y 80/00; E04G 17/02

(57) ABSTRACT

A method of producing formwork includes the steps of creating a three-dimension model of a formwork structure using a software application with the formwork structure including a plurality of panels configured for coupling to each other, fabricating each of the plurality of the panels using an additive manufacturing process, and assembling the plurality of the panels based on locating features and coupling features provided on the panels during the additive manufacturing process.

### CROSS-REFERENCE TO RELATED APPLICATION

This patent application claims priority to U.S. Provisional Patent Application Ser. No. 62/935,804, filed on Nov. 15, 2019, the entire disclosure of which is hereby incorporated herein by reference.

### FIELD OF THE INVENTION

The present invention relates to a system and method for optimizing the design, fabrication, and installation of formwork using an additive printing process.

### BACKGROUND OF THE INVENTION

The construction industry has suffered from a stagnation of productivity regarding the formation of structures using concrete or other flowable construction materials. Specifically, the design and installation of concrete formwork used to guide the formation of the final building structure suffers from numerous unaddressed inefficiencies. The current state of the design and installation process is summarized in FIG. 1.

For example, the feasibility of creating certain formwork structures is currently limited by the processes typically used in designing and assembling such formwork structures. It is common for such formwork to be created by assembling a plurality of panels or other structures into the desired configuration for forming a mold suitable for receiving the concrete. These panels are typically provided in standardized sizes and shapes, such as utilizing a variety of different standardized wooden boards. Such panels or boards are also typically provided in a limited number of configurations, wherein such panels or boards may typically include configurations exclusively comprised of rectilinear edges, planar surfaces, and 90 degree corners, such as substantially cuboid shapes. These configurations have traditionally been preferable as they are much easier to fabricate when forming basic formwork structures.

The use of the standardized panels may accordingly present situations wherein it requires substantially more planning and labor to create formwork configurations that in any way deviate from the more traditional configurations. For example, the use of curvilinear shapes or non-planar surfaces may require the creation of customized panels or the like for supplementing the otherwise rectilinear and planar standardized panels. Similarly, spacers, fillers, or cut-outs may also need to be applied to non-standard configurations to accommodate the limited configurations available when the standardized panels are otherwise used exclusively. Additional customization is also required when attempting to accommodate complimentary structures associated with the formwork structure such as steel embeds, sleeves, block outs, inserts, or the like. The need for such customization may render more complicated structures as unfeasible, as the effort required for creating such formwork structures may be cost, time, and labor prohibitive.

Additionally, the traditional method of assembling such standardized panels requires significant planning to optimize the use of such standardized panels and significant time and skill to ensure that the standardized panels are assembled in the correct configuration. For example, multiple skilled laborers may require the use of advanced surveying tools for assembling the standardized panels, and may further require additional skilled laborers for accommodating the panels to the given application, such as when additional cutting of the panels is required. These requirements may in turn greatly limit the number of laborers suitable for performing such tasks, which in turn further increases the costs associated with the design and assembly of such formwork structures.

There accordingly exists a need in the art for an improved system and method for designing, fabricating, assembling, and disassembling concrete formwork.

### SUMMARY OF THE INVENTION

Compatible and attuned with the present invention, an improved system and method for designing, fabricating, assembling, and disassembling concrete formwork has surprisingly been discovered.

According to an embodiment of the invention, a method of producing formwork includes the steps of creating a three-dimension model of a formwork structure using a software application with the formwork structure including a plurality of panels configured for coupling to each other, fabricating each of the plurality of the panels using an additive manufacturing process, and assembling the plurality of the panels.

According to another embodiment of the invention, a formwork structure comprises a plurality of panels combinable to produce a mold, each of the plurality of panels produced by an additive manufacturing process

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawings:

FIG. 1 is a diagram summarizing the current method of designing and installing formwork;

FIG. 2 is a diagram summarizing a method of designing, fabricating, installing, and reusing or recycling formwork according to an embodiment of the present invention;

FIG. 3 is a diagram summarizing a method of designing, fabricating, installing, and reusing or recycling formwork according to an embodiment of the present invention;

FIG. 4 is an exploded perspective view of an exemplary formwork structure comprised of a plurality of panels manufactured according to a method of the present invention;

FIG. 5 is a top plan view of an exemplary formwork structure comprised of a plurality of panels manufactured according to a method of the present invention;

FIG. 6 is a perspective view of an exemplary formwork structure comprised of a plurality of panels manufactured according to a method of the present invention;

FIG. 7 is an enlarged fragmentary perspective view of an exemplary formwork structure comprised of a plurality of panels manufactured according to a method of the present invention;

FIG. 8 is a perspective view of an exemplary formwork structure comprised of a plurality of panels manufactured according to a method of the present invention; and

FIG. 9 is an enlarged fragmentary perspective view of an exemplary formwork structure comprised of a plurality of panels manufactured according to a method of the present invention.

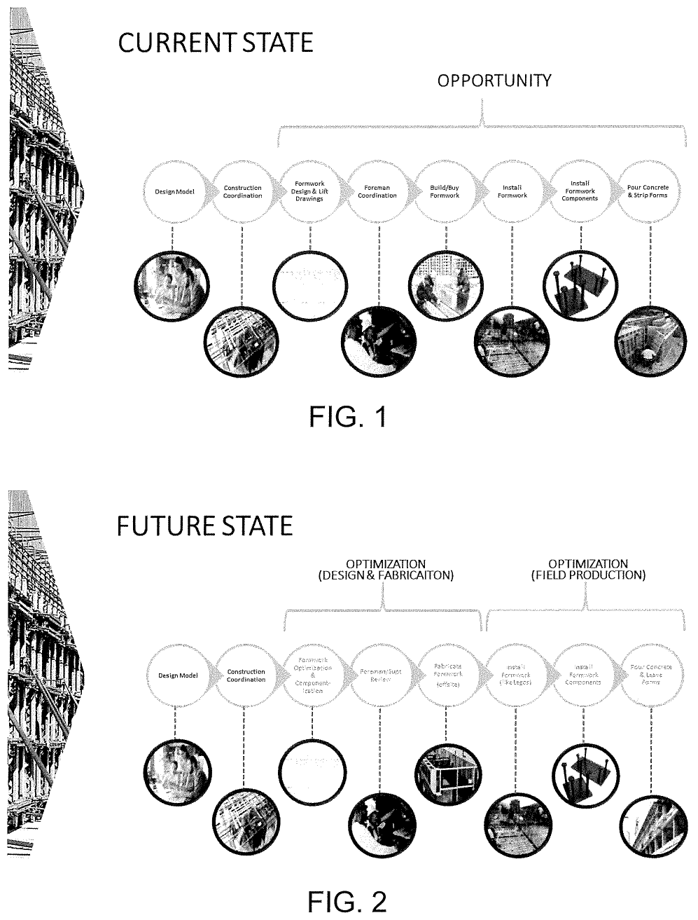

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

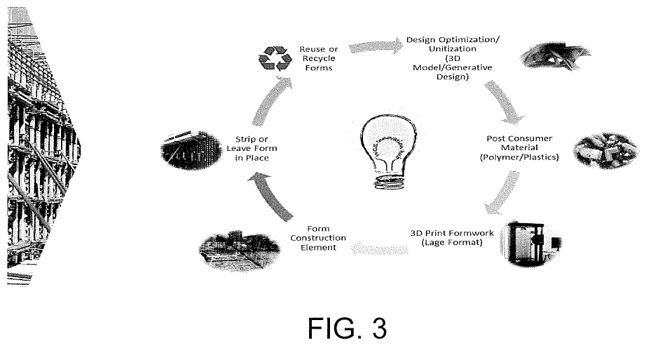

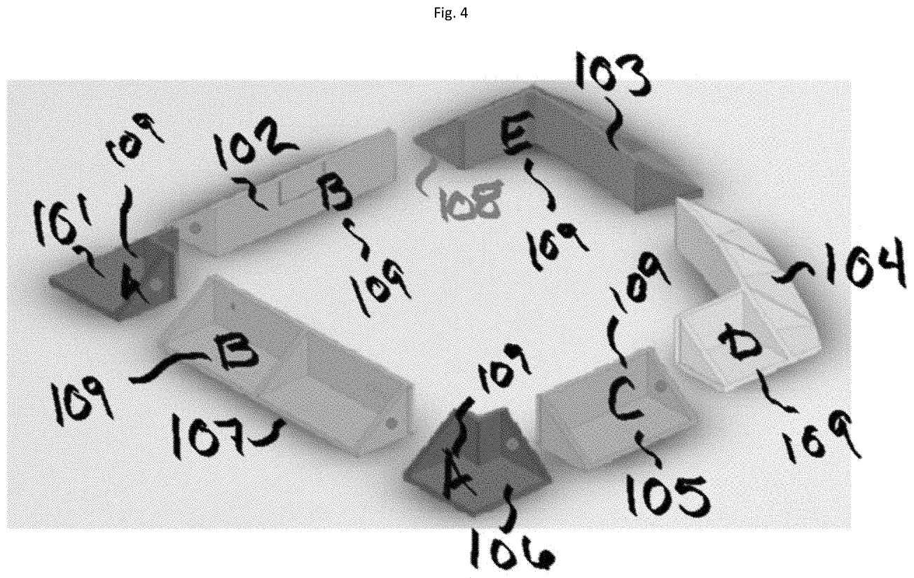

The present invention relates to a system and method for the digital fabrication of formwork. As used herein, formwork refers to structures used for forming a mold into which concrete or other flowable construction material is poured for creating what is hereinafter referred to as a building structure. The processes disclosed hereinafter are summarized by reference to FIGS. 2 and 3.

The system may include the use of a software application for designing the structure of the formwork to be fabricated with respect to the associated building structure. The application is configured to create a three-dimensional model of the formwork based on a three-dimensional model of the associated building structure. The three-dimensional model of the building structure may be an imported three-dimensional model or the application itself may be configured to produce the three-dimensional model via drafting features available as a part of the application.

Regardless of the source of the associated three-dimensional model of the building structure, the application is configured to utilize a generative design tool for designing the corresponding three-dimensional model of the formwork to be used when actually constructing the corresponding building structure. The generative design tool may be a rule-based system that automatically creates the required three-dimensional formwork structures for accommodating the provided three-dimensional structure of the building structure based on user provided information. More specifically, the rule-based system may create the associated three-dimensional geometry of the formwork structure by utilizing predefined constraints and parameters as selected by the user of the application. For example, the application may be preprogrammed by the user to include limits on various aspects of each of the structures generated such as limiting the thickness, width, height, or estimated weight of each of the structures for achieving the assembled formwork structure.

The predefined parameters and constraints may relate to various mechanical properties of the resulting formwork structure or building structure. For example, the dimensions or configuration of each associated formwork structure may be based on the mechanical properties of the formwork structures or the building structure being produced. Such mechanical properties may relate to the expected forces applied to the formwork structures during the creation of the final building structure via the reception of the concrete within the associated formwork structures. Additional predefined parameters may be utilized without departing from the scope of the present invention.

The generative design tools of the application are accordingly configured to analyze the provided three-dimensional model of the resulting building structure to optimize the form and dimensions of each associated formwork structure while also looking to create common formwork structures. The creation of common formwork structures in turn promotes the ability to reuse such formwork structures repeatedly during the construction of the resulting building structure when similar conditions are faced with respect to different portions of the building structure. These same structures may also be reused for subsequent projects having similar features, thereby eliminating additional fabrication of the structures.

The application is further configured to generate the three-dimensional model of the formwork structures with every interfacing structure or related component identified and modeled geospatially. For example, the formwork structures generated by the application may include any necessary openings, cut-outs, indentations, projections, locating features, or other structures necessary for accommodating related features of the building structure such as steel embeds, PT heads, block outs, inserts, or the like.

This geospatial modeling also promotes the ability to fabricate the formwork structures with indicia or other identifiers for more efficiently identifying the desired position of each formwork structure during a process of assembling such formwork structures, as is explained in greater detail hereinbelow. Such indicia or other identifiers may also be associated with the placement of the previously mentioned interfacing structures or related components to further simplify the assembly process of the formwork and the eventual construction of the building structure.

The application is not limited to pre-cast structures or cast in place structures as described hereinabove. The application is further configured to design stay forms that are configured to remain as a portion of the resulting building structure. One example where such stay forms may be utilized is in the creation or placement of floor sleeves. Traditionally, such floor sleeves are positioned relative to a temporary deck structure using a robotic placing system, wherein such floor sleeves form a pass-through or void in the concrete structure. In contrast, the application of the present invention is used to design a lattice system that connects to the forms and visually and accurately locates where all such features (such as the aforementioned floor sleeves) are located, as shown in FIG. 8. This process results in the creation of a built-in locking feature used to secure the corresponding element precisely where it needs to be positioned. This same process may be used for all inserts, iron, stud rails, PT cables, block outs, or the like as used in any slabs, walls, columns, or foundations forming the building structure.

Once a design is established for a project via use of the above described application, the resulting three-dimensional model that is generated by the application is used to fabricate the physical components of the formwork using additive manufacturing processes (e.g. 3D Printing). The formwork structures produced by the additive manufacturing process may be formed from various polymers or polymer mixtures, along with resins, steel, wood, or sand. These materials are intended to be post-consumer products as well as recycled products that facilitate the reuse of such materials following construction of the building structure. The additive manufacturing process may be performed by any suitable type of 3D printer (not shown) or the like, as desired. The associated 3D printer may use any additive printing process, including the use of material deposition, light sensitive polymers, thermoset polymers, or other methods, as desired.

The use of the application and the additive manufacturing process allows for the fabricated components to be customized for each and every unique project. Additionally, the use of the additive manufacturing process also allows for the inclusion of easy to produce coupling features within the printed formwork structures. The combined incorporation of the locating features and the coupling features within the printed formwork structures allows for quick assembly and disassembly of the formwork structures, even when the associated artisans have limited expertise or skill. The ease of assembly may be further facilitated by producing the formwork structures with distinct colors or patterns associated with the desired position or purpose of each of the formwork structures, as desired.

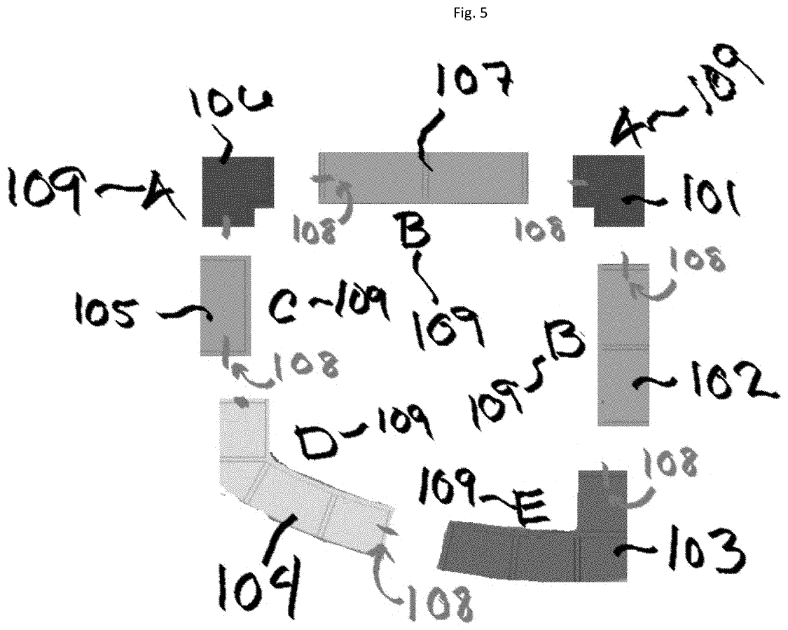

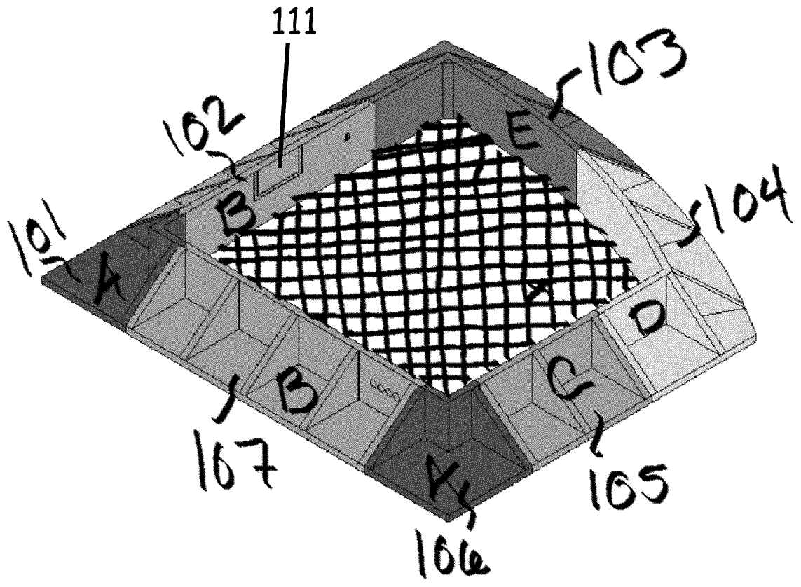

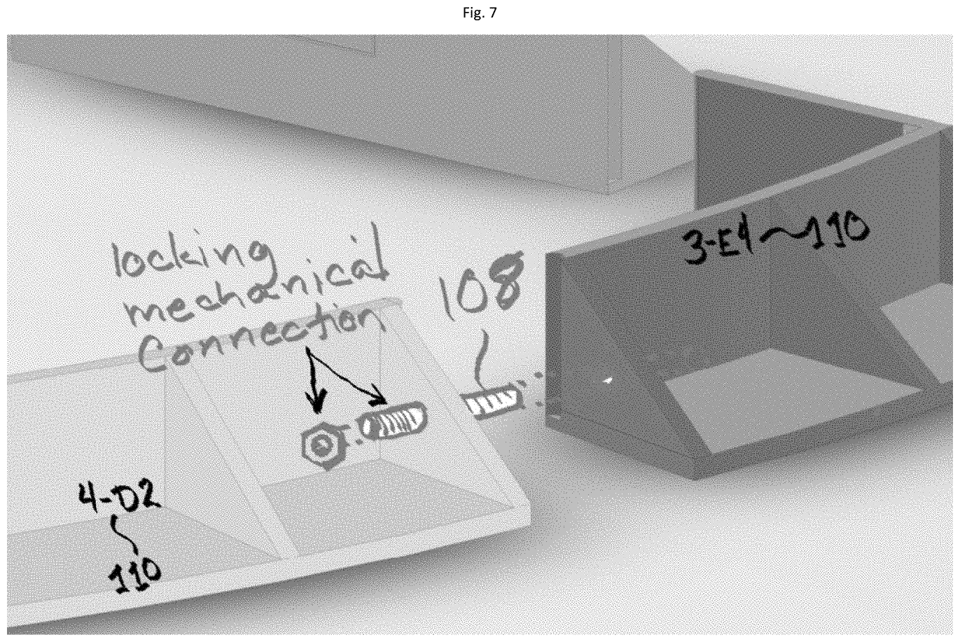

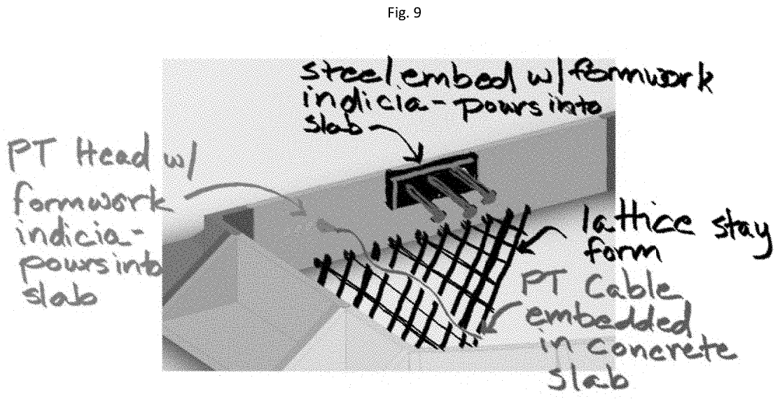

FIGS. 4-9 illustrate an example of complimentary formwork structures that may be designed using the application and fabricated using the additive manufacturing process, wherein each of the structures is hereinafter referred to as panels. However, it should be understood that the present method may be applied for forming structures having alternative shapes and configurations to those disclosed herein.

The panels include a first panel 101, a second panel 102, a third panel 103, a fourth panel 104, a fifth panel 105, a sixth panel 106, and a seventh panel 107 combinable to produce a perimeter mold for receipt of concrete therein. As shown, the third and fourth panels 103, 104 include curved non-planar surfaces that are easily produced by the additive manufacturing process in comparison to more traditional fabrication methods. One skilled in the art should appreciate that additional configurations having non-rectilinear edges or non-planar surfaces may be formed by the additive printing process, as desired.

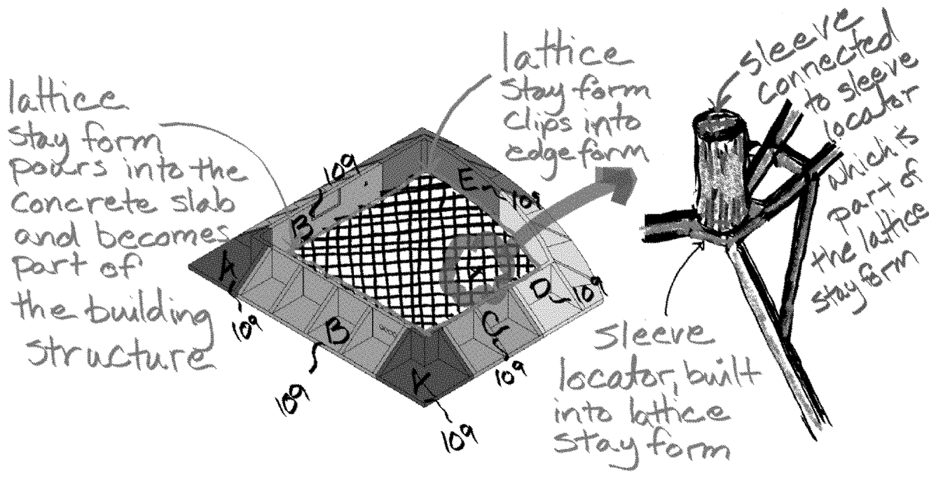

Each of the panels 101, 102, 103, 104, 105, 106, 107 further includes a plurality of coupling features 108, wherein each of the coupling features 108 is positioned for selective coupling to one of the other panels 101, 102, 103, 104, 105, 106, 107 to form the perimeter shape of the formwork (FIG. 7). In the provided example, each of the coupling features 108 is one of a threaded cylindrical projection or a cylindrical opening, wherein each of the openings is configured to receive one of the projections in a mechanical tightening manner when the panels 101, 102, 103, 104, 105, 106, 107 are in an assembled configuration. It is understood any coupling device can be used as desired such as bolts, screws, adhesives, friction fit pins and/or pegs, studs, buckles, rebar, snaps, and the like, for example. As mentioned above, each of the coupling elements or features 108 may be produced with uniform dimensions and shapes to allow for each of the panels 101, 102, 103, 104, 105, 106, 107 to be interchangeably coupled to each other. One skilled in the art will appreciate that various other structures may be used to form the coupling features 108 without departing from the scope of the present invention.

Each of the panels 101, 102, 103, 104, 105, 106, 107 is further produced to include an identifying feature 109 as well as a plurality of locating features 110. The identifying features 109 and the locating features 110 may be produced during the additive manufacturing process as raised/projecting indicia or indented indicia that are visually exposed to aid in assembling the panels 101, 102, 103, 104, 105, 106, 107, or other types of indicia such as ink based or other materials having a color, texture, or shape differing from that of the panels 101, 102, 103, 104, 105, 106, 107. For example, the additive printing process could include the use of multiple different materials with each of the materials having a different color, wherein the indicia are produced in a color different from the body of the associated panel, or wherein the panels 101, 102, 103, 104, 105, 106, 107 are provided in differing colors based on the shape and intended use of each of the panels 101, 102, 103, 104, 105, 106, 107. In the embodiment shown, each of the panels 101, 102, 103, 104, 105, 106, 107 includes one of the identifying features 109 formed in a central region thereof acting as a part identifier with the panels 101, 102, 103, 104, 105, 106, 107 labelled alphabetically as A, B, C, D, and E, respectively. Each of the coupling features 108 formed in each of the panels 101, 102, 103, 104, 105, 106, 107 is further associated with one of the locating features 110 for forming a guide in properly assembling the panels 101, 102, 103, 104, 105, 106, 107. In the provided example, each of the locating features 110 first recites a numeral associated with that specific coupling feature 108 with respect to the corresponding panel 101, 102, 103, 104, 105, 106, 107 as well as a reference to one of the coupling features 108 of an adjacent one of the panels 101, 102, 103, 104, 105, 106, 107. The labelling convention disclosed herein is merely exemplary, and is in no way intended to limit the number or type of such identifying or locating features.

The second panel 102 includes a first opening 111 formed therein. The opening 111 forms indicia on the panel intended to locate a Post Tension (PT) cable head. The PT head is connected to the form, but once poured, the form is stripped and the PT head will remain in place in the concrete. A similar indicia is on the panel to locate the steel embed. These indicators are formed directly into the panels during the additive manufacturing process to avoid the need for further cutting or machining during assembly of the formwork. Embeds, PT Heads, iron, inserts, sleeves etc. are all identified via the formwork system and then poured in place with the building structure.

The disclosed method accordingly allows the formwork to be easily labelled for ease of assembly while also allowing for essentially any shape or configuration of the formwork to be achievable. The amount of time needed to print such structures is also limited only by the deposition or formation rate of the associated additive printing process, and not by the complexity of the structures being printed. The pre-fabrication of such parts also allows for the process to be broken up and performed independently, such as allowing for the additive printing process to occur off-site of the location for the formwork. Modifications to the design are also easily achievable via use of the associated software application. The use of polymeric materials also allows for the reuse or potential recycling of the fabricated structures after completion of the resulting formwork structure.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A method of producing formwork, the method comprising the steps of:
creating a three-dimension model of a formwork structure using a software application, the formwork structure including a plurality of panels configured for coupling to each other;
fabricating each of the plurality of the panels using an additive manufacturing process; and
assembling the plurality of the panels to correspond to the three-dimensional model of the formwork structure.

2. The method of claim 1, wherein the assembling of the plurality of the panels includes referencing indicia provided on the panels.

3. The method of claim 2, wherein the referencing indicia is provided as part of the additive manufacturing process.

4. The method of claim 3, wherein the referencing indicia is a projection.

5. The method of claim 3, wherein the referencing indicia is an indentation.

6. The method of claim 1, wherein the fabricating of each of the plurality of the panels includes the formation of coupling features on each of the panels.

7. The method of claim 1, wherein the fabricating of each of the plurality of the panels includes the formation of locating features on each of the panels.

8. A formwork structure comprising:
a plurality of panels combinable to produce a mold, each of the plurality of panels produced by an additive manufacturing process.

9. The formwork structure of claim 8, further comprising a plurality of coupling elements for coupling the plurality of panels to one another.

10. The formwork structure of claim 8, further comprising an identifying feature disposed on each of the plurality of panels.

11. The formwork structure of claim 10, wherein the identifying feature is produced by the additive manufacturing process.

12. The formwork structure of claim 10, wherein the identifying feature is a projection or an indentation.

13. The formwork structure of claim 8, further comprising a locating feature disposed on each of the plurality of panels.

14. The formwork structure of claim 13, wherein the locating feature is produced by the additive manufacturing process.

15. The formwork structure of claim 13, wherein the locating feature is a projection or an indentation.

16. The formwork structure of claim 8, wherein the additive manufacturing process is a 3-D printing process.
